(19) United States
(12) Patent Application Publication
(10) Pub. No.: US 2010/0123659 A1
(43) Pub. Date: May 20, 2010

(54) IN-AIR CURSOR CONTROL

(75) Inventors: Steven Michael Beeman, Kirkland, WA (US); Landon Dyer, Medina, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/273,977

(22) Filed: Nov. 19, 2008

(51) Int. Cl. G06F 3/033

(52) U.S. Cl. 345/157

(57) ABSTRACT

Embodiments related to in-air cursor control solutions are disclosed. For example, one disclosed embodiment provides a method of moving a cursor on a display. The method comprises receiving an external motion signal from an image sensor that is external to a handheld cursor control device, receiving an internal motion signal from a motion detector internal to the handheld cursor control device, and sending an output signal to the display to change a location of the cursor on the display based upon the external motion signal and the internal motion signal.

### BACKGROUND

In-air cursor control solutions allow a cursor displayed on a display, such as a computer monitor or television, to be manipulated by a cursor control device that is held in mid-air. This is opposed to a traditional mouse, which controls a cursor by tracking motion on a surface. In-air cursor control solutions allow a user to manipulate a cursor while standing and/or moving about a room, thereby providing freedom of movement not found with traditional mice.

Some in-air cursor control devices track motion via input from gyroscopic motion sensors incorporated into the cursor control devices. However, gyroscopic motion sensors may accumulate error during use. Further, such cursor control devices may not provide acceptable performance when held still, as the signals from the gyroscopes may drift after a relatively short period of time.

### SUMMARY

Accordingly, various embodiments related to in-air cursor control solutions are disclosed herein. For example, one disclosed embodiment provides a method of moving a cursor on a display. The method comprises receiving an external motion signal from an image sensor that is external to a handheld cursor control device, receiving an internal motion signal from a motion detector internal to the handheld cursor control device, and sending an output signal to the display to change a location of the cursor on the display based upon the external motion signal and the internal motion signal.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a view of an embodiment of an in-air cursor control device use environment.

FIG. 2 is a block diagram of the embodiment of FIG. 1.

FIG. 3 is a flow diagram depicting an embodiment of a method of moving a cursor on a display.

FIG. 4 is a flow diagram depicting another embodiment of a method of moving a cursor on a display.

FIG. 5 is a schematic depiction of a movement of a reference frame when a cursor is moved to a location outside of an original area of the reference frame.

FIG. 6 is a schematic depiction of a movement of an optical target from a region within a field of view of a pair of image sensors to a region within a field of view of a single image sensor.

### DETAILED DESCRIPTION

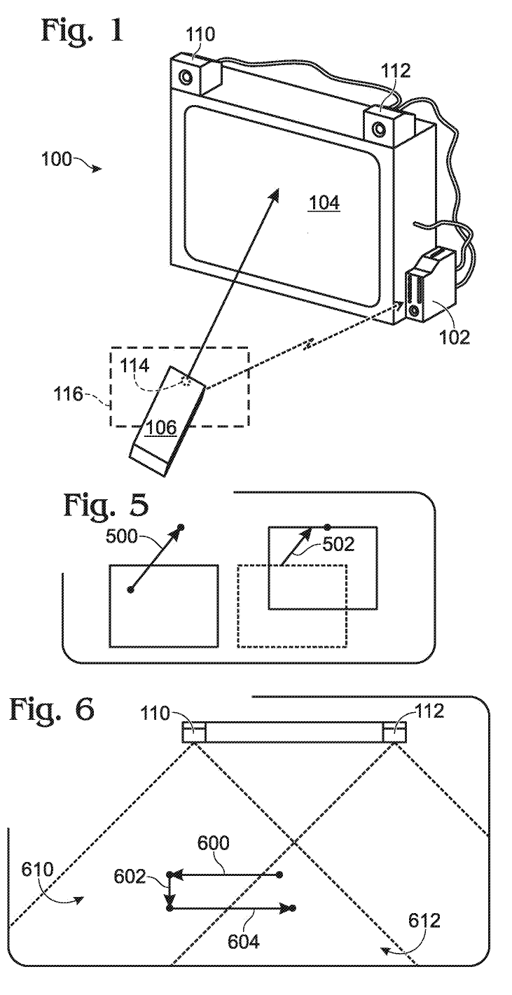

FIG. 1 shows an example embodiment of an in-air cursor control use environment in the form of an interactive entertainment system 100. The interactive entertainment system 100 comprises a computing device 102, such as a game console, connected to a display 104 on which a user may view and interact with a video game, various media content items, etc. The interactive entertainment system 100 further comprises an in-air cursor control device 106 configured to manipulate a cursor displayed on the display 104 during interactive media play. It will be understood that the term “cursor” as used herein signifies any object displayed on display 104 that may be moved on the display 104 via the cursor control device 106.

The depicted interactive entertainment system 100 further includes a first image sensor 110 and a second image sensor 112 facing outwardly from the display 104 such that the image sensors 110, 112 can capture an image of a target 114 on the cursor control device 106 when the cursor control device 106 is within the field of view of image sensors 110, 112. In some embodiments, the target 114 may be a light source, such as a light-emitting diode (LED) or the like. In other embodiments, the target 114 may be a reflective element configured to reflect light emitted from a light source located on the computing device 102, on one or more of the image sensors 110, 112, or at any other suitable location. In one specific embodiment, the target 114 comprises an infrared LED, and image sensors 110, 112 are configured to detect infrared light at the wavelength(s) emitted by the target 114. In other embodiments, the image sensors and target may have any other suitable spatial relationship that allows the sensors to detect the target.

While the depicted embodiment shows a cursor control device with a single target, it will be understood that a cursor control device also may comprise multiple targets of varying visibility for use in different applications. Further, a cursor control device also may comprise a single target with a mechanism for altering a visibility of the target. One example of such an embodiment may comprise an LED that is positioned within a reflector such that a position of the LED relative to the reflector can be changed to alter a visibility of the target. Additionally, while the image sensors 110, 112 are shown as being located external of the display 104, it will be understood that the image sensors also may be located internal to the display 104, to a set-top console (i.e. where computing device 102 is used in a set-top configuration), or in any other suitable location or configuration.

When interacting with the computing device 102, a user may point the cursor control device 106 toward the image sensors 110, 112, and then move the cursor control device 106 in such a manner that the image sensors 110, 112 can detect motion of the target 114. This motion may be projected onto a reference frame 116 defined on a plane between the target 114 and the display 104. Then, the location of the target on the reference frame may be used to determine an external measure of cursor location on the display by correlating the location of the target 114 within the reference frame 116 to a location on the display 104. Signals from the image sensors 110, 112 may be referred to herein as “external motion signals.”

Further, the cursor control device 106 also may comprise internal motion sensors to detect motion of the cursor control device 106. Signals from the motion sensors may then be sent to the computing device 102 wirelessly or via a wired link, thereby providing an internal measure of cursor location to the computing device. Such signals may be referred to herein as “internal motion signals.” The computing device 102 then may use the internal and external measures of cursor location to determine a location on the display at which to display the cursor in response to the motion of the cursor control device 106. Any suitable type of internal motion sensor may be used. Examples include, but are not limited to, inertial motion sensors such as gyroscopes and/or accelerometers.

It will be understood that the terms “internal” and “external” as used herein refer to a location of the motion detector relative to the cursor control device 106. The use of both internal and external measures of cursor location help to reduce problems of “drift” and accumulated error that may occur with the use of internal motion sensors alone. Likewise, this also may help to avoid the problems with sensitive or jittery cursor movement due to hand tremors and other such noise that can occur through the use of external optical motion sensors alone.

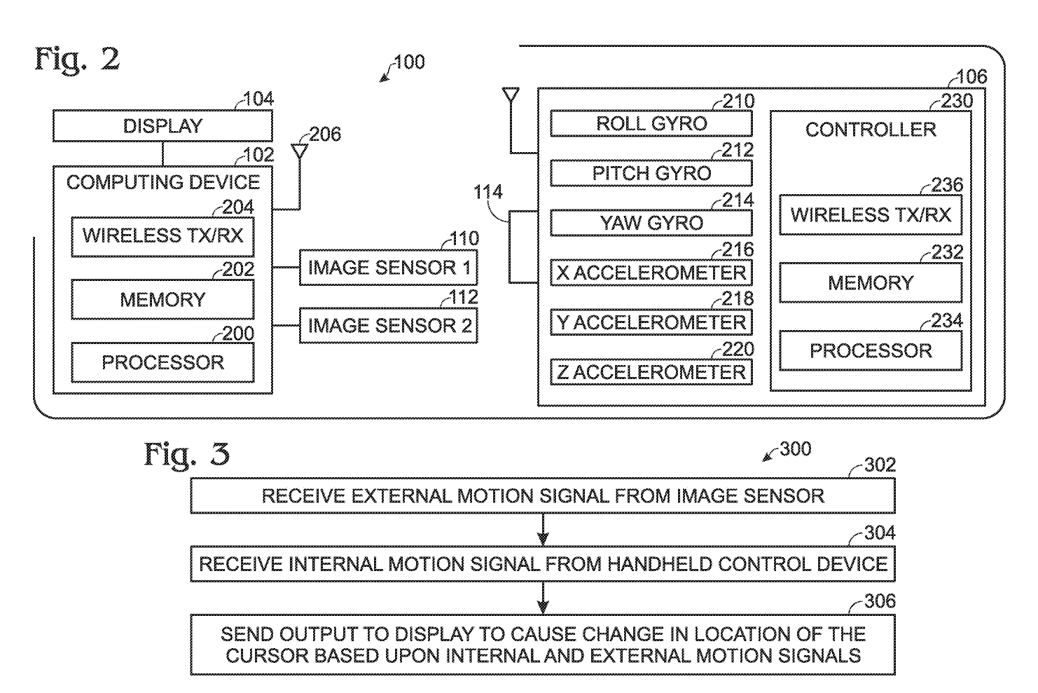

FIG. 2 shows a block diagram of the interactive entertainment system 100. In addition to the components shown and discussed above in the context of FIG. 1, the computing device 102 comprises a processor 200, and memory 202 that contains instructions executable by the processor 200 to perform the various methods disclosed herein. Further, the computing device may include a wireless transmitter/receiver 204 and an antenna 206 to allow wireless communication with the cursor control device 106. While the depicted embodiment comprises two image sensors 110, 112, in other embodiments, a single image sensor may be used, or three or more image sensors may be used. The use of two or more image sensors, instead of a single image sensor, allows motion in a z-direction (i.e. along an axis normal to the surface of display 104) to be detected via the image sensors.

The cursor control device 106 comprises a plurality of motion sensors, and a controller configured to receive input from the sensors and to communicate the signals to the computing device 102. In the depicted embodiment, the motion sensors include a roll gyroscope 210, a pitch gyroscope 212, a yaw gyroscope 214, and x, y, and z accelerometers 216, 218, 220. The gyroscopes 210, 212, and 214 may detect movements of the cursor control device 106 for use in determining how to move a cursor on the display 104. Likewise, the accelerometers may allow changes in orientation of the cursor control device 106 to be determined, and which may be used to adjust the output received from the gyroscopes to the orientation of the display. In this manner, motion of the cursor on the display 104 is decoupled from an actual orientation of the cursor control device 106 in a user's hand. This allows motion of the cursor to be calculated based upon the movement of a user's hand relative to the display, independent on the orientation of the cursor control device in the user's hand or the orientation of the user's hand relative to the rest of the user's body

Additionally, the cursor control device 106 comprises a controller 230 with memory 232 that may store programs executable by a processor 234 to perform the various methods described herein, and a wireless receiver/transmitter 236 to enable processing of signals from the motion sensors and/or for communicating with the computing device 102. It will be understood that the specific arrangement of sensors in FIG. 2 is shown for the purpose of example, and is not intended to be limiting in any manner. For example, in other embodiments, the cursor control device may include no accelerometers. Likewise, in other embodiments, motion may be detected by pairs of accelerometers instead of gyroscopes.

FIG. 3 shows an embodiment of a method 300 of controlling cursor motion on a display via signals from an image sensor external to a cursor control device and a motion sensor internal to the cursor control device. First, method 300 comprises, at 302, receiving an external motion signal from the image sensor, and at 304, receiving an internal motion signal from a handheld cursor control device. Then, method 300 comprises sending an output signal to a display, wherein the output signal is configured to change a location of the cursor on the display.

In this manner, method 300 uses both an internal reference frame (i.e. motion sensors) and an external reference frame (i.e. image sensors) to track the motion of the cursor control device. This may allow the avoidance of various shortcomings of other methods in-air cursor control. For example, as described above, in-air cursor control devices that utilize internal motion sensors for motion tracking may accumulate error, and also may drift when held still. In contrast, the use of image sensors as an additional, external motion tracking mechanism allows for the avoidance of such errors, as the image sensors allow a position of the target to be detected with a high level of certainty to offset gyroscope drift. Likewise, in-air cursor control devices that utilize image sensors to detect motion may be highly sensitive to hand tremors and other such noise, and therefore may not display cursor motion in a suitably smooth manner. The use of internal motion sensors as an additional motion detecting mechanism therefore may help to smooth cursor motion relative to the user of image sensors alone.

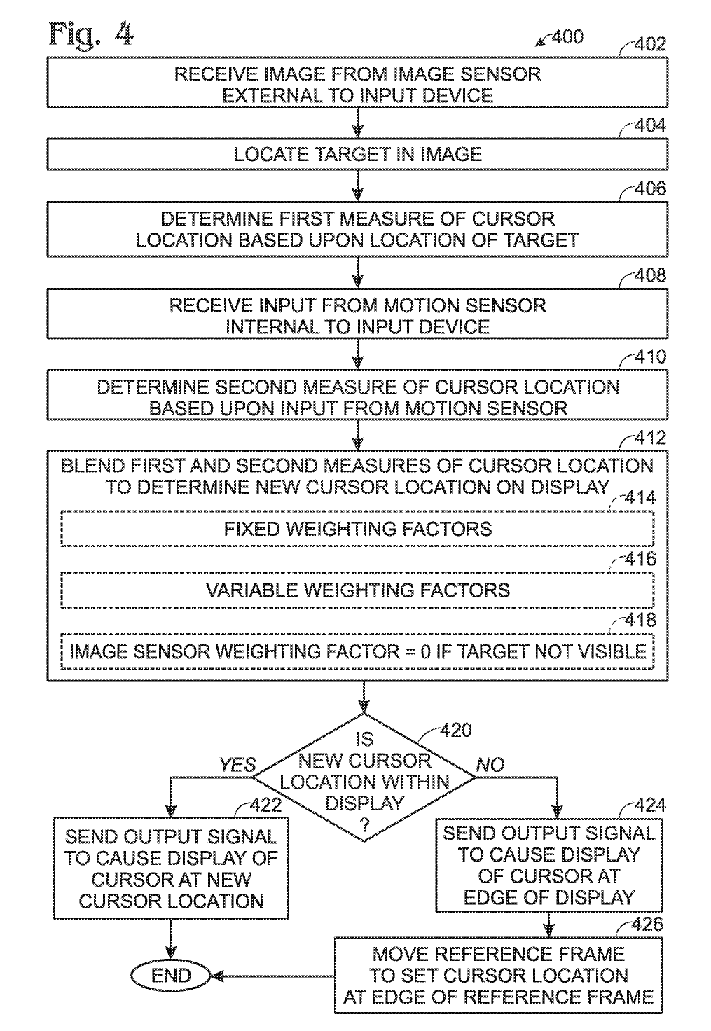

Method 300 may be implemented in any suitable manner. FIG. 4 shows an embodiment of a method 400 of controlling cursor movement on a display that illustrates an example of a more detailed implementation of method 300. Method 400 first comprises, at 402, receiving an image from an image sensor located external to an in-air cursor control device, and then, at 404, locating a target in the image. As described above, the target may comprise an LED or other light emitter incorporated into the cursor control device, a reflective element on the cursor control device, or any other suitable item or object that is visible to the image sensor(s) employed. It will be understood that locating the target in the image may comprise various sub-processes, such as ambient light cancellation, distortion correction, and various other image processing techniques. In the event that the target cannot be located in the image, then the input from the internal motion sensors may be used to determine a new cursor location, as described below. While described in the context of “an image sensor”, it will be understood that method 400 may be used with any suitable number of image sensors, including a single sensor, or two or more sensors.

After locating the target in the image, method 400 comprises, at 406, determining a first measure of cursor location based upon the location of the target in the image. The first measure of cursor location may be determined in any suitable manner. For example, as described above in the discussion of FIG. 1, a reference frame may be defined at a location between the cursor control device and the display, and then the determined location of the target may be projected onto the reference frame to determine a location of the cursor on the screen. The size, shape and orientation of the reference frame may be selected to correspond to a natural zone of motion of a user's hand and/or arm so that a user can move the cursor across a display screen without utilizing gestures that are uncomfortably large, or that are too small to allow the careful control of fine cursor movements. In one specific embodiment, the reference frame may be defined as being parallel to a user's body (for example, a vertical plane that extends through both of a user's shoulders), and that is located in a z-direction (i.e. normal to a plane of the display) such that the target on the cursor control device is in the vertical plane of the reference frame. In such an embodiment, an example of a suitable size and shape for the reference frame is a rectangular reference frame having a horizontal dimension of 120 mm and a vertical dimension of 80 mm. In other embodiments, the reference frame may have any other suitable orientation, location, size and/or shape.

Method 400 next comprises, at 408, receiving input from one or more motion sensors internal to the cursor control device. In some embodiments, input may be received from a combination of gyroscopes and accelerometers, as described above. In other embodiments, input may be received from any other suitable internal motion sensor or combination of sensors.

Next, at 410, method 400 comprises determining a second measure of cursor location based upon the input from the motion sensor. This may be performed, for example, by continuously totaling the signal from each motion sensor, such that the signal from each motion sensor is added to the previous total signal from that motion sensor to form an updated total. In this manner, the second measure of cursor location comprises, or otherwise may be derived from, the updated total for each motion sensor. For example, where a combination of gyroscopes and accelerometers is used to determine the second measure of cursor location, the signals from the gyroscopes may be used to determine a magnitude of the motion of the cursor control device in each direction, and the signals from the accelerometers may be used to adjust the signals from the gyroscopes to correct for any rotation of the cursor control device in a user's hand. This allows motion of the cursor to be calculated based upon the movement of a user's hand relative to the display, independent on the orientation of the cursor control device in the user's hand or the orientation of the user's hand relative to the rest of the user's body.

Next, at 412, method 400 comprises blending the first and second measures of cursor location to determine a new location of the cursor on the display. Blending the first and second measures of cursor location may help to avoid drift and accumulated error that may arise in motion sensor-based in-air cursor control techniques, while also avoiding the sensitivity to hand tremors and other such noise that may arise in optical in-air cursor control methods.

The first and second measures of cursor location may be blended in any suitable manner. For example, as indicated at 414, each measure of cursor location may be multiplied by a fixed weighting factor, and then the summed to determine a new location of the cursor on the display. As a more specific example, in one embodiment, the external motion signal from the image sensor may be multiplied by a weighting factor of 0.3, and the internal motion signal from the gyroscopes and/or accelerometers may be multiplied by a weighting factor of 0.7, as follows:

New cursor location (x)=0.3(image x)+0.7(gyro x)

New cursor location (y)=0.3(image y)+0.7(gyro y)

It will be understood that these calculations may be performed after adjusting for the orientation of the cursor control device using accelerometer outputs, and also after adjusting for the location of the cursor control device in a z direction, which may affect the determination of cursor location from the image sensor signals. It will be understood that the above examples of weighting factors are shown for the purpose of example, and are not intended to be limiting, as any other suitable weighting factors may be used.

In other embodiments, as indicated at 416, variable weighting factors may be used to blend the internal measure of cursor location and the external measure of cursor location. For example, in some embodiments, a comparatively greater weight may be applied to the external measure of cursor location compared to the internal measure of cursor location for large magnitude movements, whereas a comparatively smaller weight may be applied to the external motion signal for smaller magnitude movements. Further, in some embodiments, an acceleration of the movement of a cursor on the display may be increased with increases in the magnitude of the cursor movement as determined by the image sensors.

At times, the target may become temporarily invisible to the image sensors. This may occur, for example, if someone walks between the image sensors and the targets, or if a user who is holding the cursor control device steps out of the field of view of the image sensors. Therefore, as indicated at 418, if the target cannot be located in the image from the image sensor, then the external measure of cursor location may be given a weighting factor of zero while it is invisible. In this manner, motion may continue to be tracked and displayed on the display even when the target is invisible. Once the target becomes visible again, any error accumulated during the period of target invisibility may be corrected.

After blending the first and second measures of cursor location, method 400 next comprises at 420, determining whether the new cursor location is within the boundary of the display, or if the cursor control movement made by the user would move the cursor to a location outside of the display. If the new cursor location is located within the display, as indicated at 422, then method 400 comprises displaying the cursor at the determined new cursor location on the display, for example, by sending an output signal to the display to cause the display of the cursor at the new location.

On the other hand, if the new cursor location would be outside of the display, then an output signal is sent to cause the cursor to be displayed at the edge of the screen, as indicated at 424, and the reference frame is moved to set the cursor location at a corresponding edge of the reference frame, as indicated at 426. This is illustrated in FIG. 5, where the movement of the cursor location is indicated by arrow 500 and the corresponding movement of the reference frame is indicated by 502. In this manner, if a user walks to a new location during use of the cursor control device, the reference frame moves with the user so that the user can resume normal use at the new location.

Method 400 may be performed at any frequency suitable to show movement of a cursor on a display. Suitable frequencies include, but are not limited to, frequencies that allow cursor motion to be displayed without noticeable jumps between image frames. In one specific implementation, signals from the image sensors and motion sensors are received at eight millisecond intervals, which corresponds to a frequency of 125 Hz. It will be understood that this specific embodiment is presented for the purpose of example, and is not intended to be limiting in any manner.

In embodiments that utilize more than one image sensor, there may be times when the target is moved from a region in which both image sensors can see the target to a region in which a single image sensor can see the target. This is illustrated in FIG. 6, where the image sensors are shown at 110 and 112, and wherein movement of the cursor location is indicated by arrows 600, 602 and 604. First, arrow 600 illustrates movement of the target from a region 612 visible by both image sensors to a region 610 visible by one image sensor, and arrow 602 illustrates motion in the z-direction in region 610. In this case, motion in the z-direction may be determined from internal motion sensors while the target is visible to one image sensor. Then, when the target is moved back into region 612 visible by both image sensors, as indicated by arrow 604, z-motion tracking may again be performed by blending internal and external z-motion signals from the internal motion sensors and image sensors, respectively.

It will be appreciated that the computing devices described herein may be any suitable computing device configured to execute the programs described herein. For example, the computing devices may be a game console, mainframe computer, personal computer, laptop computer, portable data assistant (PDA), computer-enabled wireless telephone, networked computing device, or other suitable computing device. As used herein, the term “program” refers to software or firmware components that may be executed by, or utilized by, one or more computing devices described herein, and is meant to encompass individual or groups of executable files, data files, libraries, drivers, scripts, database records, etc. It will be appreciated that a computer-readable storage medium may be provided having program instructions stored thereon, which upon execution by a computing device, cause the computing device to execute the methods described above and cause operation of the systems described above.

While disclosed herein in the context of specific example embodiments, it will be appreciated that the configurations and/or approaches described herein are exemplary in nature, and that these specific embodiments or examples are not to be considered in a limiting sense, because numerous variations are possible. The specific routines or methods described herein may represent one or more of any number of processing strategies such as event-driven, interrupt-driven, multi-tasking, multi-threading, and the like. As such, various acts illustrated may be performed in the sequence illustrated, in parallel, or in some cases omitted. Likewise, the order of any of the above-described processes is not necessarily required to achieve the features and/or results of the embodiments described herein, but is provided for ease of illustration and description. The subject matter of the present disclosure includes all novel and nonobvious combinations and subcombinations of the various processes, systems and configurations, and other features, functions, acts, and/or properties disclosed herein, as well as any and all equivalents thereof.

1. A method of moving a cursor on a display, comprising:
receiving an external motion signal from an image sensor that is external to a handheld cursor control device;
receiving an internal motion signal from a motion detector internal to the handheld cursor control device; and
sending an output signal to the display, the output signal being configured to change a location of the cursor on the display based upon the external motion signal and the internal motion signal.

2. The method of claim 1, wherein receiving an external motion signal comprises receiving an image from the image sensor and detecting in the image a location of a target on the handheld cursor control device.

3. The method of claim 2, wherein, if the location of the target on the handheld cursor control device cannot be detected in the image, then sending an output signal to the display based upon the internal motion signal.

4. The method of claim 2, wherein detecting the location of the target comprises detecting light emitted by the handheld cursor control device.

5. The method of claim 2, wherein detecting the location of the target comprises detecting light reflected by the handheld cursor control device.

6. The method of claim 1, wherein receiving an internal motion signal comprises receiving a signal from an accelerometer.

7. The method of claim 1, wherein receiving an internal motion signal comprises receiving a signal from a gyroscopic motion sensor.

8. The method of claim 1, wherein receiving an external motion signal comprises receiving images from two or more image sensors.

9. The method of claim 1, further comprising blending the external motion signal and the internal motion signal, and wherein the output signal comprises a location of the cursor on the display determined from the blend of the external motion signal and the internal motion signal.

10. The method of claim 9, wherein blending the external motion signal and the internal motion signal comprises applying fixed weighting factors to the external motion signal and the internal motion signal.

11. The method of claim 9, wherein blending the external motion signal and the internal motion signal comprises applying variable weighting factors to the external motion signal and the internal motion signal.

12. A computer-readable storage medium comprising computer-readable instructions executable by a computing device to perform a method of receiving an input from a wireless, in-air handheld input device and moving a cursor displayed on a display in response to the input, the method comprising:
receiving an image from an image sensor external to the handheld input device;
locating in the image a target on the handheld input device;
determining a first measure of cursor location based upon a location of the target in the image relative to a reference frame that occupies an area within the image;
receiving an input from a motion detector internal to the handheld input device;
determining a second measure of cursor location based upon the input from the motion sensor;
determine a new cursor location on the display from the first measure of cursor location and the second measure of cursor location;
if the new cursor location is located within a boundary of the display, then displaying the cursor at the new cursor location on the display;
if the new cursor location is located outside of a boundary of the display screen, then displaying the cursor at edge of screen, and moving the reference frame to set the cursor location at a corresponding edge of reference frame.

13. The computer-readable storage medium of claim 12, wherein the instructions are executable to determine the new cursor location by blending the first measure of cursor location and the second measure of cursor location.

14. The computer-readable storage medium of claim 13, wherein blending the first measure of cursor location and the second measure of cursor location comprises applying fixed weighting factors to the first measure of cursor location and the second measure of cursor location.

15. The computer-readable storage medium of claim 13, wherein blending the first measure of cursor location and the second measure of cursor location comprises applying variable weighting factors to the first measure of cursor location and the second measure of cursor location.

16. A computing device, comprising:
a processor; and
memory comprising instructions stored thereon that are executable by the processor to performing a method of moving a cursor on a display, the method comprising:
receiving an external motion signal from an image sensor that is external to a handheld cursor control device;
determining a first measure of cursor location based upon the external motion signal;
receiving an internal motion signal from a motion detector internal to the handheld cursor control device;
determining a second measure of cursor location based upon the internal motion signal;
blending the first measure of cursor location and a second measure of cursor location to determine a new cursor location on the display; and
sending an output signal to the display to move the cursor to the new cursor location on the display.

17. The computing device of claim 16, wherein the instructions are executable to blend the first measure of cursor location and the second measure of cursor location by weighting the first measure of cursor location and the second measure of cursor location, and then adding the first measure of cursor location and the second measure of cursor location.

18. The computing device of claim 17, wherein weighing comprises applying fixed weighting factors to the first measure of cursor location and the second measure of cursor location.

19. The computing device of claim 17, wherein weighting comprises applying variable weighting factors to the first measure of cursor location and the second measure of cursor location.

20. The computing device of claim 17, wherein receiving an external motion signal comprises detecting in the image from the image sensor a target located on the handheld cursor control device, and wherein weighting comprises applying a weighting factor of zero to the first measure of cursor location if the target is not visible in the image from the image sensor.
